(19) United States
(12) Patent Application Publication
(10) Pub. No.: US 2026/0003149 A1
(43) Pub. Date: Jan. 1, 2026

(54) CASSETTE WITH REVERSIBLE SECURING COMPONENT AND SYSTEM

(71) Applicant: Belden Canada ULC, Saint-Laurent (CA)

(72) Inventors: Lucas RAKOTO-SAM, Laval (CA); Simon LYONNAIS-BOURQUE, Montreal (CA); Dwayne CRAWFORD, Point-Claire (CA)

(73) Assignee: Belden Canada ULC, Saint-Laurent (CA)

(21) Appl. No.: 19/323,166

(22) Filed: Sep. 9, 2025

Related U.S. Application Data
(63) Continuation of application No. 17/932,560, filed on Sep. 15, 2022, now Pat. No. 12,411,300.
(60) Provisional application No. 63/261,222, filed on Sep. 15, 2021.

(51) Int. Cl. G02B 6/44; G02B 6/46

(52) U.S. Cl. CPC G02B 6/4453; G02B 6/562

(57) ABSTRACT

A reversible fiber optic cassette for mounting in a rack comprising a cassette receiving tray, the tray comprising a plurality of cassette engaging features is disclosed. The cassette comprises a cassette body comprising optic fiber receptacles arranged along a front of thereof, a multifiber receptacle along a back thereof and a plurality of optic fiber segments each between a respective one of the optic fiber receptacles and the multifiber receptacle, and a securing component comprising a main part comprising a first surface and a second surface opposite the first surface, a cassette engaging part extending from the first surface for engaging with the cassette body, a tray engaging feature extending from the second surface and engageable with one of the cassette engaging features. The reversible securing component is secureable on either side of the cassette body using the cassette engaging feature.

### CROSS REFERENCE TO RELATED APPLICATIONS

This Application is a continuation of U.S. application Ser. No. 17/932,560, filed Sep. 15, 2022, which claims priority under 35 USC § 119(e) of U.S. provisional application Ser. No. 63/261,222 filed on Sep. 15, 2021, which are incorporated herein in their entireties by reference.

### FIELD OF THE INVENTION

The present invention relates to a cassette with reversible securing component and system.

### BACKGROUND TO THE INVENTION

The prior discloses reversible fiber optic cassettes for use with other cassettes on a tray. One drawback of these prior art cassettes is that they require two sets of features, one on each side of the cassette, in order to secure and remove the cassette from the tray.

### SUMMARY OF THE INVENTION

The present addresses the above and other drawbacks by providing a reversible fiber optic cassette for mounting in a rack comprising a cassette receiving tray, the tray comprising a plurality of cassette engaging features. The cassette comprises an elongate cassette body comprising a plurality of optic fiber receptacles arranged along a front of thereof, a multifiber receptacle along a back thereof and a plurality of optic fiber segments, each of the segments between a respective one of the optic fiber receptacles and the multifiber receptacle, and a securing component comprising: a main part comprising a first surface and a second surface opposite the first surface, a cassette engaging part extending from the first surface for engaging with the cassette body, and a tray engaging feature extending from the second surface and engageable with one of the cassette engaging features. The reversible securing component is secureable on either side of the cassette body using the cassette engaging feature.

There is also provided a reversible fiber optic cassette system comprising a tray comprising a plurality of cassette engaging features, and at least one cassette, each of the at least one cassette comprising an elongate cassette body and a reversible securing component comprising a main part comprising a first surface and a second surface opposite the first surface, a cassette part feature extending from the first surface for engaging with the cassette body, and a tray engaging feature extending from the second surface and configured for engaging with one of the cassette engaging features and wherein the reversible securing component is secureable on either side of the cassette body.

Additionally, there is provided a securing component for mounting a cassette to a cassette receiving tray, the tray comprising a plurality of cassette engaging features and the cassette comprising a cassette body. The securing component comprises a main part comprising a first surface and a second surface opposite the first surface, a cassette engaging part extending from the first surface for engaging with the cassette body, and a tray engaging feature extending from the second surface and engageable with one of the cassette engaging features. The reversible securing component is secureable on either side of the cassette body using the cassette engaging feature.

### BRIEF DESCRIPTION OF THE DRAWINGS

FIG. 1A provides a raised front right assembled perspective view of a cassette with reversible securing component and system in accordance with an illustrative embodiment of the present invention;

FIG. 1B provides a raised front right exploded perspective view of a cassette with reversible securing component and system in accordance with an illustrative embodiment of the present invention;

FIG. 2A provides a raised front right perspective view of a cassette with reversible securing component in accordance with an illustrative embodiment of the present invention;

FIG. 2B provides a raised rear right perspective view of a cassette with reversible securing component in accordance with an illustrative embodiment of the present invention;

FIG. 2C provides a raised front right exploded perspective view of a cassette with reversible securing component in accordance with an illustrative embodiment of the present invention;

FIG. 3A provides a raised right front perspective view of a securing component in accordance with an illustrative embodiment of the present invention;

FIG. 3B provides a raised right front perspective view of a reversed securing component in accordance with an illustrative embodiment of the present invention; and

FIG. 4 provides a raised front right exploded perspective view of a cassette with reversible securing component in accordance with an alternative illustrative embodiment of the present invention.

### DETAILED DESCRIPTION OF THE ILLUSTRATIVE EMBODIMENTS

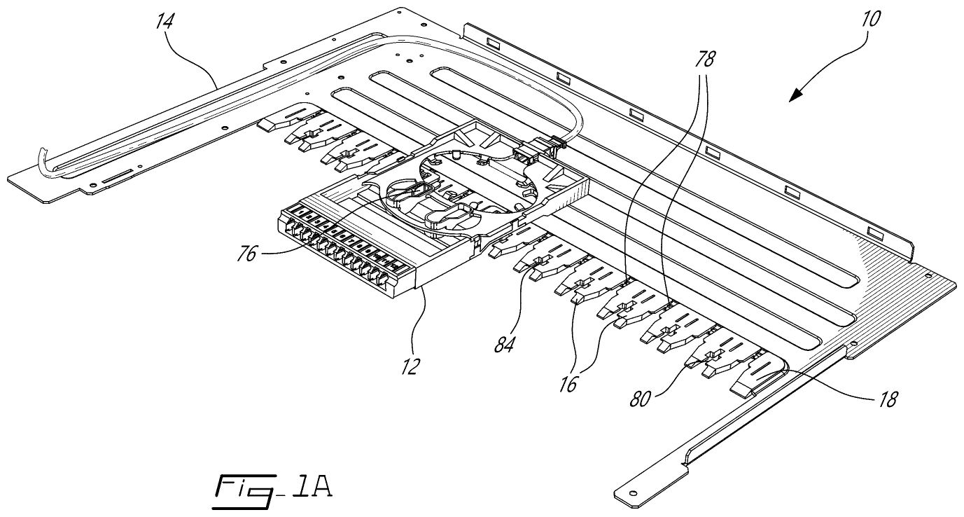

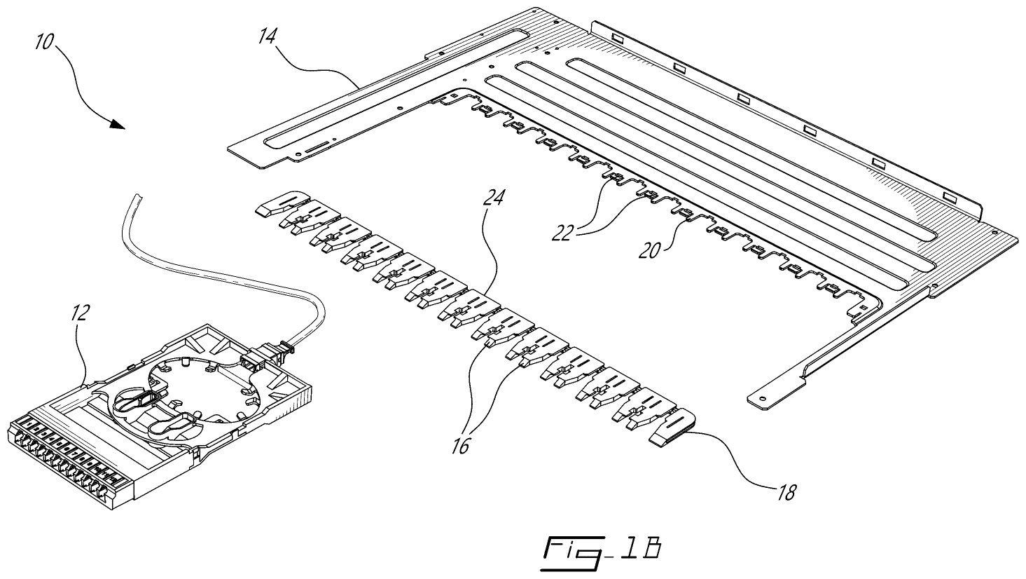

Referring now to FIG. 1A, a reversible fiber optic cassette with reversible securing component and system, generally referred to using the reference numeral 10, will now be described. The system 10 comprises one or more cassettes 12 which are arrangeable side by side and releasably mounted to a tray 14 comprising a plurality of cassette engaging features 16. The tray 14 is typically slideably mounted with other trays in a case which is dimensioned for securing in a 19″ inch rack or the like (both not shown).

Referring to FIG. 1B in addition to FIG. 1A the cassette engaging features 16 are illustratively molded as a strip 18 from a rigid material such as plastic and mounted on a forward edge 20 of the tray 14. In this regard, the forward edge 20 of the tray 14 comprises features 22 which engage with molded features (not shown), such as tabs or the like, within the rearward edge 24 of the strip 18. The strip 18 is assembled to the forward edge 20 of the tray 14 by inserting the forward edge 20 in the rearward edge 24 of the strip 18 until the features 22 are engaged by the tabs or the like.

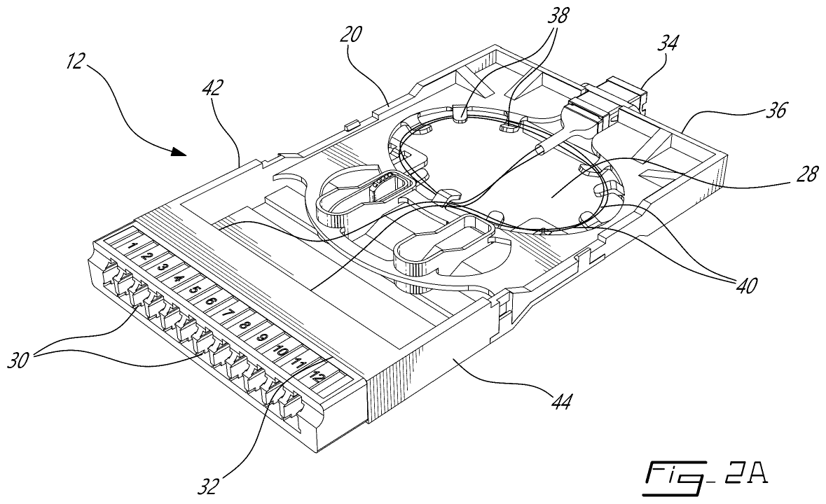

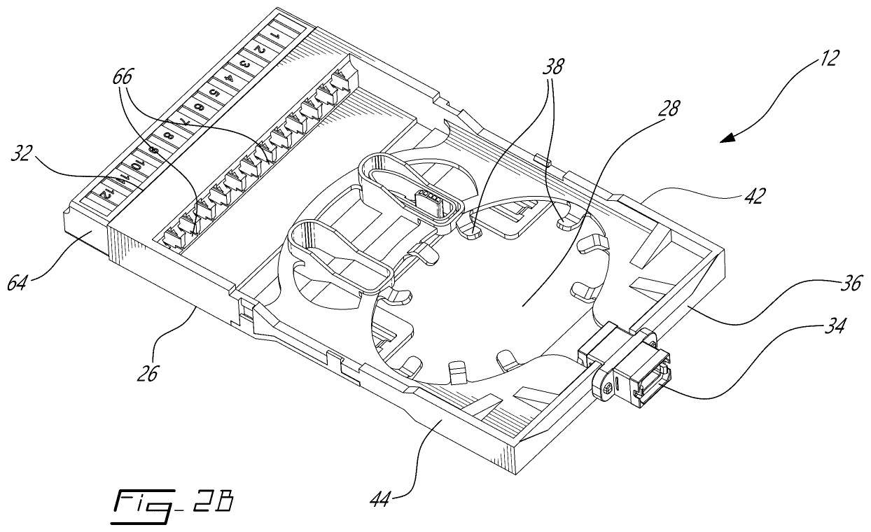

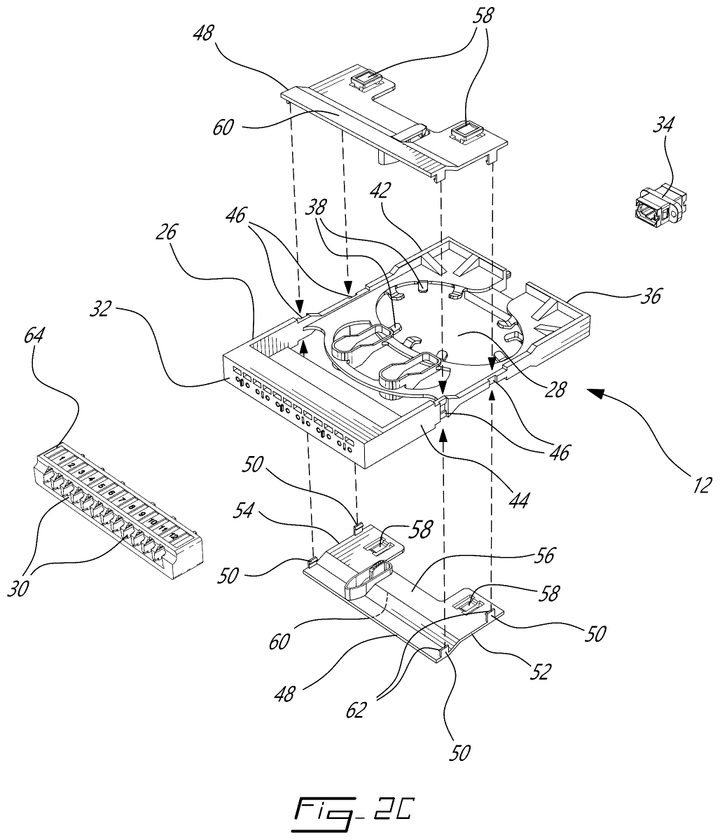

Referring now to FIGS. 2A through 2C, each cassette 12 comprises an elongate cassette body 26 or frame comprising a cable receiving region 28, a plurality of optic fiber receptacles 30 arranged along a front 32 of the cassette body 26 and illustratively a multifiber receptacle 34 arranged along a back thereof 36. In one embodiment the optic fiber receptacles 30 are configured for receiving a standard LC type plug for example terminating a single fiber optic cable or the like (both not shown). Additionally, the spacing between the optic fiber receptacles 30 is such that any two optic fiber receptacles 30 can receive two plugs (also not shown) in a duplex configuration. In one embodiment the multi fiber receptacle 34 is configured for receiving a standard MPO type plug terminating a 12X multi-fiber cable or the like (both not shown). The cable receiving region 28 comprises a plurality of retaining features 38 arranged along a generally circular path to receive and retain a plurality of optic fiber segments 40.

Still referring to FIGS. 2A through 2C, the cassette body 26 further comprises a pair of opposed side edges 42, 44 interconnecting the front 32 and the back 36. Referring to FIG. 2C, each of the side edges 42, 44 comprises a pair of outward facing slots 46 therein. A removable and reversible securing component 48 is also provided which comprises a main part dimensioned to fit sideways across the cassette body 26, illustratively towards a center thereof. The securing component 48 comprises a cassette engaging part for engaging with the cassette body 26 and comprising pairs of opposed flexible fingers 50 positioned along respective outer edges 52, 54 of the securing component 48 extending away from a first surface 56 thereof. Additionally, there are provided a pair of stabilising tabs 58 extending away from a second surface 60 of the securing component 48 and which are engageable with selected ones of the cassette engaging features 16.

Referring to FIG. 2C, the reversible securing component 48 is mountable to a selected side of the cassette body 26 (both mounting options are shown in FIG. 2C, although a person of ordinary skill in the art will understand that only one option is useable at a time) by aligning the flexible fingers 50 with respective ones of the outward facing slots 46 and inserting the flexible fingers 50 into the outward facing slots 46. Hook features 62 on the flexible fingers 50 releasably engage with the opposed side edges 42, 44 thereby removably securing the reversible securing component 48 to the cassette body 26.

Referring to FIGS. 2B and 2C, in one embodiment the receptacles 30 are molded together as a block 64, illustratively a block 64 of twelve (12) LC type receptacles. Similarly, an inside of the front 32 comprises a plurality of receptacles 66 molded or otherwise formed therein. In one embodiment, the receptacles 66 are configured for receiving a standard LC type plug (not shown) for example terminating a single fiber optic cable (reference 40 in FIG. 2A) or the like. The block 64 of receptacles 30 is attached to the front 32 for example by sonic welding, a suitable adhesive or the like and such that the receptacles 30 align with the receptacles 68, with each receptacle 30/receptacle 68 pair acting as a coupler assembly interconnecting optic fibers (not shown) terminated at each receptacle 30, 68 pair and such that the ferrules (not shown) of each of the terminated optic fibers are arranged along the same axis.

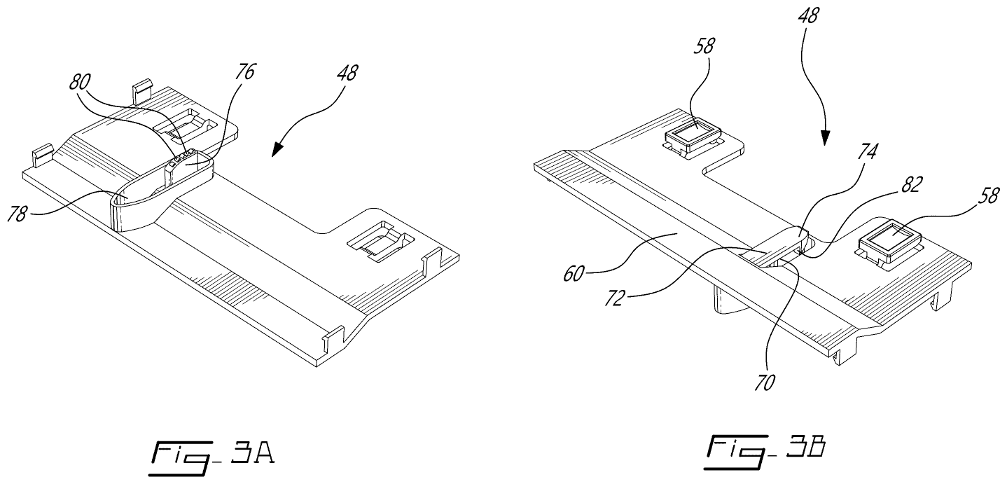

Referring now to FIG. 1 and FIGS. 3A and 3B, the reversible securing component 48 further comprises a tray engaging feature 70 comprising a fixed end 72 and a flexible end 74 extending from the second surface 60 of the reversible securing component 48. An actuator 76 is further provided which extends from the flexible end 74 through an aperture 78 in the main part. The actuatable surface of the actuator 76 comprises a series of small bumps 80 to prevent a user's finger from slipping when pressing the actuator 76. As a person of ordinary skill in the art will now understand, the actuatable surface of the actuator 76 is accessible from the accessible side of the cassette 12 when the cassette 12 is installed on the tray 14.

Still referring to FIG. 1 and FIGS. 3A and 3B, on insertion of the cassette 12 onto the tray 14, the stabilising tabs 58 are engaged by respective ones of a plurality of slots 78 in the strip 18 while the actuator 76 is slid into a slot 80 in the selected cassette engaging feature 16 and a hook 82 on the flexible end 74 of the tray engaging feature 70 moves into an aperture 84 in the cassette engaging feature 16. A person of ordinary skill in the art will now understand that the hook 82 is biased into the aperture 84 by the flexible end 74 and such that the cassette 12 is securely held to the tray 14. Similarly, in order to release the cassette 12 from the tray 14, the actuator 76 is depressed thereby biassing the hook 82 out of the aperture 84 in the cassette engaging feature 16 thereby allowing the cassette 12 to be retracted from the tray 14.

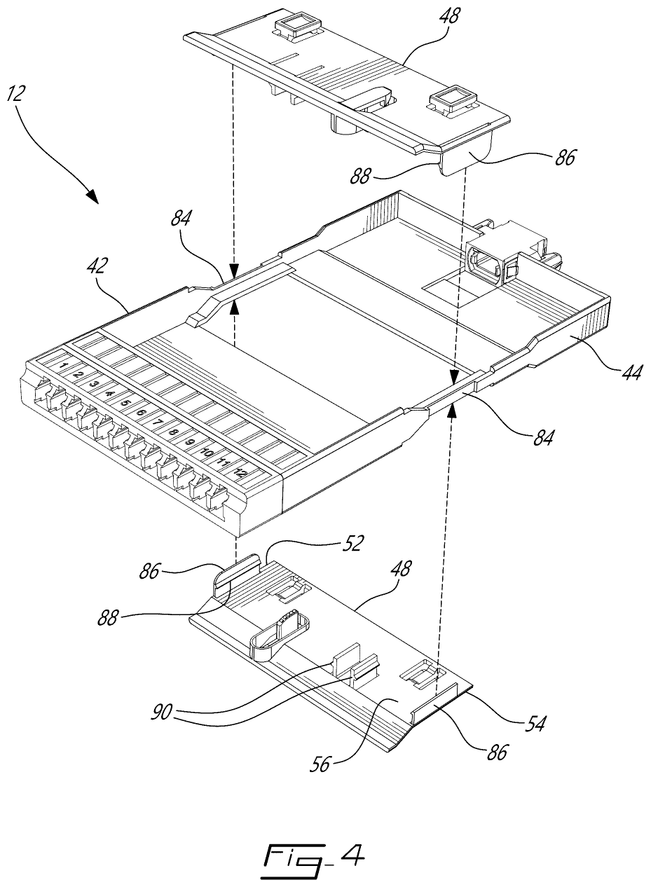

Referring now to FIG. 4, in an alternative embodiment of a cassette 12, each of the side edges 42, 44 comprises an outward facing slot 84 therein. The securing component 48 comprises a pair of opposed flexible tabs 86 positioned on respective outer edges 52, 54 of the securing component 48 and extending away from a first surface 56 thereof. Additionally, there are provided a pair of tray stabilising tabs 58 extending away from a second surface 60 of the securing component 48. The reversible securing component 48 is mountable to a selected side of the cassette body 26 (both mounting options are shown in FIG. 4, although a person of ordinary skill in the art will understand that only one option is useable at a time) by aligning the flexible tabs 86 with respective ones of the outward facing slots 84 and inserting the flexible tabs 86 into the outward facing slots 84. Hook features 88 on the flexible tabs 86 engage with the opposed side edges 42, 44 thereby removably securing the reversible securing component 48 to the cassette body 26. In a particular embodiment, provision can also be made for securing a cable manager or the like (not shown) for example by providing additional securing features 90 on the first surface 56 of the securing component 48.

Although the present invention has been described hereinabove by way of specific embodiments thereof, it can be modified, without departing from the spirit and nature of the subject invention as defined in the appended claims. Claims

1. A fiber optic cassette configured to provide enhanced cassette reverse mounting orientation configurations in a tray comprising:
a cassette body portion comprising a optic fiber receptacle configured to be arranged along a cassette body front side portion of the cassette body portion, a multifiber receptacle portion configured to extend along a cassette body rear side portion of the cassette body portion, and a plurality of optic fiber segment portions configured such that at least one of the optical fiber segment portions is located between the multifiber receptacle portion and the optic fiber receptacle portion; and
a securing cassette portion comprising:
a main securing portion that includes a first main portion surface and a second main portion surface configured to be located substantially opposite to the first main portion surface;
a cassette body engaging portion structurally configured to extend from the first main portion surface so as to engage the cassette body portion; and
a tray engaging portion structurally configured to extend from the second main portion surface so as to provide enhanced cassette reverse mounting orientation configurations in a tray by selectively engaging the cassette engaging portion so as to selectively allow the securing portion to be secured to the cassette body front side portion when the cassette is in a first cassette orientation and selectively allow the securing portion to be secured to the cassette body rear side portion when the cassette is in a second cassette orientation that is substantially reversed relative to first cassette orientation.

2. The cassette of claim 1, wherein the tray further comprises a plurality of slot portions and the securing cassette portion further comprises at least one stabilizing tab portion configured to be engaged within at least a portion of at least one of the plurality of slot portions.

3. The cassette of claim 1, wherein the main securing portion is structurally configured to fit substantially sideways across at least a portion of the cassette body portion.

4. The cassette of claim 3, wherein the main securing portion is structurally configured to fit sideways across a portion of the cassette body portion towards a center portion of the cassette body portion.

5. The cassette of claim 1, further comprising a plurality of optic fiber receptacle portions arranged along the cassette body front side portion.

6. The cassette of claim 3, wherein the cassette body portion comprises an outward facing cassette body slot portion, wherein the cassette body engaging portion comprises a flexible finger portion that is configured to engage with the outward facing slots portion so as to provide the enhanced cassette reverse mounting orientation configurations by selectively allowing the securing cassette portion to be secured to either side of the cassette body portion.

7. The cassette of claim 1, further comprising an actuator portion configured to extend from a flexible end portion of the tray engaging portion through an aperture portion of the main securing portions so as to allow the tray engaging portion to be selectively disengaged from an engaged portion of the cassette body engaging portion such that when the securing cassette portion is mounted on the cassette body front side portion, the actuator portion is configured to be actuated from the cassette body rear side portion.

8. A device for providing enhanced optical fiber cassette mounting orientation configurations in a tray comprising:
a cassette securing portion having a first cassette securing surface portion configured to face a first direction and a second cassette securing surface portion configured to face a second direction that is different from the first direction;
a cassette engaging portion configured to extend from the first cassette securing surface portion so as to engage the cassette body portion; and
a tray engaging cassette portion configured to extend from the second cassette securing surface portion so as to provide enhanced cassette reverse mounting orientation configurations in a tray by selectively allowing the cassette securing portion to be secured to the first cassette securing surface portion when the cassette is in a first cassette orientation and selectively allowing the cassette securing portion to be secured to the second cassette securing surface portion when the cassette is in a second cassette orientation that is different from the first cassette orientation.

9. The device of claim 8, wherein first cassette orientation is substantially reversed relative to the first cassette orientation.

10. The device of claim 8, further comprising a first cassette tab portion configured to securely engage a tray slot portion when the cassette is in the first cassette orientation and a second cassette tab portion configured to securely engage the tray slot portion when the cassette is in the second cassette orientation.

11. The device of claim 8, wherein the cassette securing portion comprises a main securing portion that includes the first cassette securing surface portion and the second cassette securing surface portion.

12. The device of claim 11, further comprising a cassette body portion having a center cassette body portion, and wherein the main securing portion is structurally configured to fit sideways across the cassette body portion towards the cassette body portion.

13. The device of claim 8, comprising a plurality of cassettes configured to be arranged side by side on a tray.

14. The device of claim 13, wherein at least one of the plurality of cassettes includes a front cassette portion, a rear cassette portion, a plurality of optic fiber cassette receptacle portions configured to be arranged along the front cassette portion, a multifiber receptacle portion configured to be arranged along the rear cassette portion, and a plurality of optic fiber segment portions each configured to be arranged between a respective one of the optic fiber cassette receptacle portions and the multifiber receptacle portion.

15. The device of claim 8, further comprising a cassette that includes a front cassette portion, a rear cassette portion, an optic fiber cassette receptacle portion configured to be arranged on the front cassette portion, a multifiber receptacle portion configured to be arranged on the rear cassette portion, and an optic fiber segment portion configured to be arranged between the optic fiber cassette receptacle portion and the multifiber receptacle portion.

16. The device of claim 8, further comprising a cassette body that includes a pair of opposed side cassette body edge portions configured to be connected to a front cassette portion and a rear cassette portion, and a pair of outward facing slot portions in each of the opposed side cassette body edge portions, and wherein the cassette engaging portion comprises a pair of opposed flexible finger portions that are configured to engage the pair of outward facing slot portions so as to provide the enhanced cassette reverse mounting orientation configurations.

17. The device of claim 8, further comprising a cassette body that includes a front side cassette body edge portion configured to be connected to a front cassette portion, a rear side cassette body edge portion configured to be connected to a rear cassette portion, a front outward facing slot portion located in the front side cassette body edge portion, a rear outward facing slot portion located in the rear side cassette body edge portion, and wherein the cassette engaging portion comprises a flexible finger portion that is configured to selectively engage the front outward facing slot portion or the rear outward facing slot portion so as to provide the enhanced cassette reverse mounting orientation configurations.

18. The device of claim 8, further comprising an actuator portion configured to extend from a flexible end portion of the tray engaging cassette so as to allow the tray engaging cassette portion to be selectively disengaged from the cassette engaging portion so as to provide the enhanced cassette reverse mounting orientation configurations.

19. The device of claim 18, wherein the cassette securing portion comprises a main securing portion having a main securing aperture portion, and the actuator portion is configured to extend through the main securing aperture portion.

20. The device of claim 8, further comprising an actuator portion configured to extend from a flexible end portion of the tray engaging cassette such that the actuator portion is configured to be actuated from the second cassette securing surface portion when the cassette securing portion is mounted on the first cassette securing surface portion, and wherein the cassette securing portion comprises a main securing portion having a main securing aperture portion, and the actuator portion is configured to extend through the main securing aperture portion.

21. The device of claim 10, wherein the first cassette tab portion extends from the first cassette securing surface portion.

22. The device of claim 10, wherein the second cassette tab portion extends from the second cassette securing surface portion.

23. A device for providing enhanced optical fiber cassette orientations comprising:
a cassette tray interlocking mount structure structurally configured to provide enhanced cassette mounting orientations in a tray by selectively allowing a cassette to be secured in a tray when the cassette is in a first cassette orientation and by selectively allowing the cassette to be secured in the tray when the cassette is in a second cassette orientation that is substantially reversed from the first cassette orientation.

24. The device of claim 23, wherein the cassette tray interlocking mount structure comprises:
a cassette securing portion having a first cassette securing surface portion configured to face a first direction and a second cassette securing surface portion configured to face a second direction that is different from the first direction;
a cassette engaging portion configured to extend from the first cassette securing surface portion so as to engage the cassette body portion; and
a tray engaging cassette portion configured to extend from the second cassette securing surface portion so as to provide the enhanced cassette mounting orientations in the tray by selectively allowing the cassette securing portion to be secured to the first cassette securing surface portion when the cassette is in a non-reversed cassette orientation and selectively allowing the cassette securing portion to be secured to the second cassette securing surface portion when the cassette is in a reversed cassette orientation that is reversed from the first cassette orientation.

25. The device of claim 24, wherein the cassette securing portion comprises a main securing portion that includes the first cassette securing surface portion and the second cassette securing surface portion.

26. A device for providing enhanced optical fiber cassette orientations comprising:
a tray portion comprising a cassette engaging portion; and
a cassette portion comprising an elongate cassette body portion and a securing portion;
wherein the securing portion is structurally configured to engage with the cassette body portion;
wherein the securing portion includes a tray engaging portion structurally configured to engage with the cassette engaging portion; and
wherein the securing component is structurally configured to be secured on either side of the cassette body so as to permit the cassette portion to be coupled with the tray portion in reversed configurations.
